(19) United States
(12) Patent Application Publication
(10) Pub. No.: US 2007/0104144 A1
(43) Pub. Date: May 10, 2007

(54) Control of reverse link packet forwarding in a wireless communications system

(75) Inventor: Srinivasan Balasubramanian, San Diego, CA (US)

Correspondence Address: COATS & BENNETT, PLLC, 1400 Crescent Green, Suite 300, Cary, NC, 27518, US

(73) Assignee: Telefonaktiebolaget LM Ericsson (publ)

(21) Appl. No.: 11/268,128

(22) Filed: Nov. 7, 2005

(51) Int. Cl. H04Q 7/00

(52) U.S. Cl. 370/331

(57) ABSTRACT

An approach to controlling packet forwarding in a wireless communications system that helps limit the burden placed on internal communication links while maintaining some or all of the advantages of diversity gain on the reverse link. A primary base station sends its peers a forwarding control message if a packet is successfully received. If the forwarding control message is received at the peer base stations before a timer elapses, the peer base stations refrain from forwarding their versions of the packet to the call anchor. The timer's duration may be varied as appropriate, and the forwarding control message process may be bypassed for small packets and/or certain application types.

### BACKGROUND OF THE INVENTION

The present invention relates to wireless communications systems; and, more particularly, to methods of controlling the forwarding of reverse link packets in the wireless communications system.

The demand for wireless data services, such as mobile Internet, video streaming, and voice over IP (VoIP), have led to the development of high speed packet data channels to provide high data rates needed for such services. High speed packet data channels are employed on the forward and reverse links in a variety of mobile communication systems, including TIA-2000 (also known as 1xEV-DV), TIA-856 (also known as 1xEV-DO), and Wideband Code Division Multiple Access (WCDMA) systems. For the forward link, the high speed packet data channel is a time shared channel, with downlink transmissions, e.g., from a base station to the mobile stations, time-multiplexed and typically transmitted at full power. For the reverse link, the high speed packet data traffic channel carries uplink transmissions, e.g., from a mobile station to a base station, that are code-multiplexed and transmitted at a closely controlled power level.

In most systems, a mobile station is typically served at any given time on the downlink by a single serving base station. However, it is common for the reverse link packets from the mobile station to be received by a plurality of base stations. The multiple receiving base stations then forward the received packets to a call anchor node in the system for combining. Thus, some measure of diversity gain is realized on the reverse link. However, in order to achieve this diversity gain, some additional burden is placed on the communication links internal to the system, such as A13 links between base stations, in forwarding the packets from multiple base stations.

### SUMMARY OF THE INVENTION

The present invention provides an approach that helps limit the burden placed on the communication links internal to the wireless communications system while maintaining some or all of the advantages of diversity gain on the reverse link. To achieve this, one of the base stations, denoted the primary base station, sends its peers a forwarding control message if a packet is successfully received. In response to receiving the forwarding control message in a timely fashion, the peer base stations, denoted as secondary base stations, refrain from forwarding their versions of the packet to the call anchor. Thus, a form of selection combining is imposed where a packet successfully received by a “first among equals” base station is used by the call anchor if possible, with packets from the other base stations becoming relevant if the packet is not successfully received by the “first among equals” base station.

In one embodiment, the present invention provides a method of controlling packet forwarding operations of base stations in a wireless communications system, comprising a first base station: receiving a reverse link packet from a mobile station; determining if the packet was successfully received by the first base station; and selectively sending a forwarding control message to at least one other peer base station based on the determining, the forwarding control message instructing the other base station to refrain from forwarding the packet to a call anchor associated with the mobile station. The first base station advantageously also forwards the packet to the call anchor in response to the packet being successfully received. The first base station may also condition the sending of the forwarding control message on the size of the reverse link packet and/or an application type associated with the reverse link packet. The first base station advantageously also functions as the downlink serving base station for the mobile station substantially contemporaneously with the receiving. A corresponding apparatus is also described.

In another embodiment, the present invention provides a method of controlling packet forwarding operations of a base station in a wireless communications system, comprising: successfully receiving a reverse link packet from a mobile station at a secondary base station; buffering the packet; receiving a corresponding forwarding control message from a primary base station instructing the secondary base station to refrain from forwarding the packet to a call anchor associated with the mobile station; and the secondary base station selectively refraining from forwarding the packet to the call anchor based on the forwarding control message. The secondary base station may forward the packet to the call anchor if a predetermined time period elapses before the receipt of the corresponding forwarding control message. The predetermined time period may vary based on an application type associated with the reverse link packet. A corresponding apparatus is also described.

In another embodiment, the present invention provides a method of controlling packet forwarding operations of base stations in a wireless communications system, comprising: successfully receiving a reverse link packet from a mobile station at a secondary base station; determining whether to forward or refrain from forwarding the packet from the secondary base station to a call anchor associated with the mobile station based upon whether a corresponding forwarding control message is received from a primary base station prior to an expiration of a predetermined time period after the successful receipt of the packet; and wherein the secondary base station refrains from forwarding the packet to the call anchor if the forwarding control message is received prior to the expiration. A corresponding apparatus is also described.

In another embodiment, the present invention provides a method of controlling packet forwarding operations of base stations in a wireless communications system, comprising: successfully receiving a reverse link packet from a mobile station at a plurality of base stations, including a primary base station and at least one secondary base station; the base stations normally programmed to forward the packet to an anchor processor responsible for the mobile station for selection combining at the anchor processor; in response to the successful receipt of the packet, the primary base station sending a forwarding control message to at least one secondary base station; each of the secondary base stations respectively selectively refraining from forwarding the packet to the anchor processor in response to receiving the forwarding control message prior to an expiration of a predetermined time period after the successful receipt of the packet by the secondary base station.

### BRIEF DESCRIPTION OF THE DRAWINGS

FIG. 1 shows an exemplary wireless communication system.

FIG. 2 shows an exemplary base station from FIG. 1.

FIG. 3 shows another exemplary wireless communications system.

FIG. 4 shows an exemplary base station from FIG. 3.

FIG. 5 shows reverse link communications from a mobile station to several base stations.

FIG. 6 shows a flowchart for a process according to one embodiment of the present invention.

### DETAILED DESCRIPTION OF THE INVENTION

The present invention relates to controlling packet forwarding operations in a wireless communications system having a plurality of mobile stations operating therein. As such, a brief overview of exemplary wireless communications systems may aid in understanding the present invention.

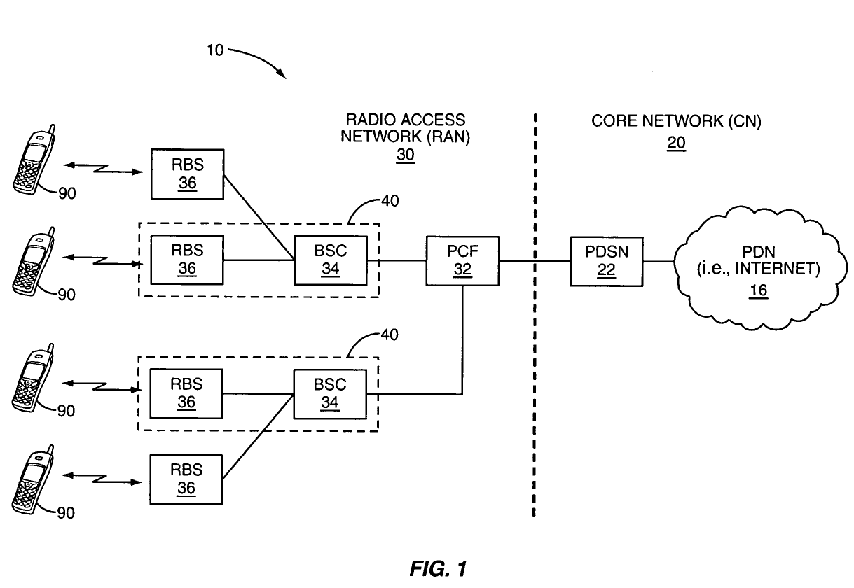

FIG. 1 illustrates the logical entities of an exemplary wireless communication network 10 that provides packet data services to mobile stations 90. In general, the wireless communication network 10 may be configured according to the TIA-2000 standard, W-CDMA standard, 1xEV-DO, or other standard. Advantageously, the wireless communication network 10 is a packet-switched network that employs a Forward Traffic Channel (FTC) to transmit traffic data to the mobile stations 90 and a Reverse Traffic Channel (RTC) to receive traffic data from the mobile stations 90. Wireless communication network 10 includes a packet-switched core network 20 and a radio access network (RAN) 30. The core network 20 includes a Packet Data Serving Node (PDSN) 22 that connects to an external packet data network (PDN) 16, such as the Internet, and supports PPP connections to and from the mobile stations 90. Core network 20 adds and removes IP streams to and from the RAN 30 and routes packets between the external packet data network 16 and the RAN 30.

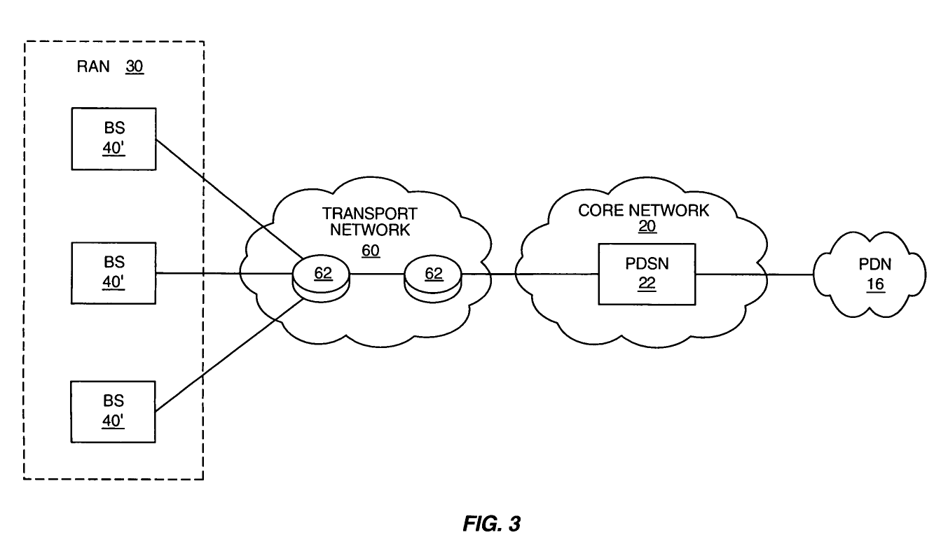

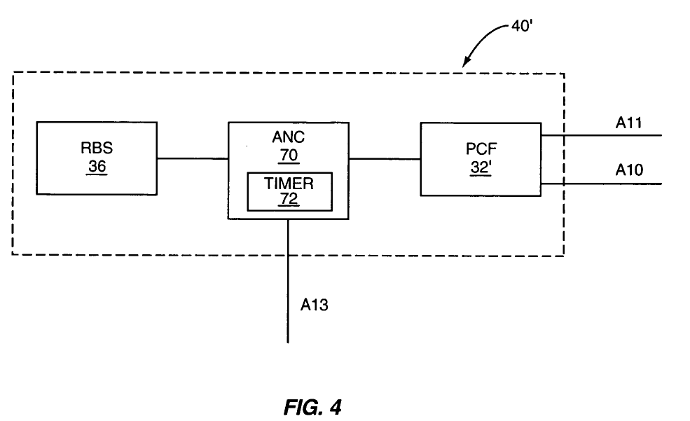

RAN 30 connects to the core network 20 and gives mobile stations 90 access to the core network 20. RAN includes a Packet Control Function (PCF) 32, one or more base station controllers (BSCs) 34 and one or more radio base stations (RBSs) 36. The primary function of the PCF 32 is to establish, maintain, and terminate connections to the PDSN 22. The BSCs 34 manage radio resources within their respective coverage areas. The RBSs 36 include the radio equipment for communicating over the air interface with mobile stations 90. A BSC 34 can manage more than one RBS 36. In this illustrative embodiment, a BSC 34 and an RBS 36 comprise a base station 40, while the BSC 34 is the control part of the base station 40. The RBS 36 is the part of the base station 40 that includes the radio equipment and is normally associated with a cell site. As shown, a single BSC 34 may function as the control part of multiple base stations 40. In other network architectures, the network components comprising the base station 40 may be different, but the overall functionality will be the same or similar. For example, see the discussion below regarding FIGS. 3-4.

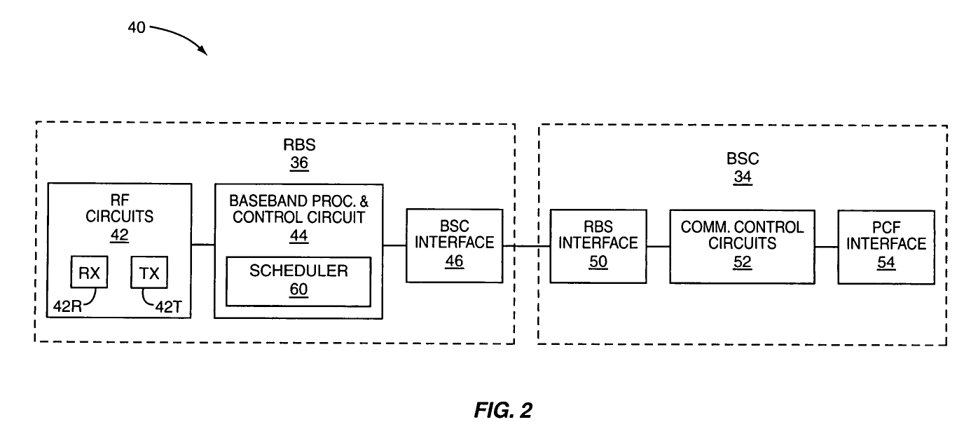

Referring to FIG. 2, the components in the exemplary base station embodiment are distributed between a RBS 36 and a BSC 34. The RBS 36 includes RF circuits 42, baseband processing and control circuits 44, and interface circuits 46 for communicating with the BSC 34. The RF circuits 42 include one or more transmitters 42T and receivers 42R, which transmit signals to, and receive signals from, the mobile stations 40. For example, the receiver 42T receives reverse link data packets transmitted by the mobile stations 90 and passes the same on to the baseband processing and control circuits 44 for processing. The baseband processing and control circuits 44 perform baseband processing of transmitted and received signals. In the embodiment shown in FIG. 2, the baseband processing and control circuit 44 includes a scheduler 60 to schedule packet data transmissions on the Forward Traffic Channel (FTC). The scheduler 60 makes scheduling decisions and selects the appropriate modulation and coding schemes for downlink transmissions based on, inter alia, channel feedback from the mobile stations 90. The baseband processing and control circuit 44 may be implemented as one or more processing circuits, comprising hardware, software, or any combination thereof, that are configured as appropriate to implement one or more of the processes described herein. For example, the baseband processing and control circuit 44 may be implemented as stored program instructions executed by one or more microprocessors or other logic circuits included in RBS 36.

The BSC 34 includes interface circuits 50 for communicating with the RBS 36, communication control circuits 52, and interface circuits 54 for communicating with PCF. The communication control circuits 52 manage the radio and communication resources used by the base station 40. The communication control circuits 52 are responsible for setting up, maintaining and tearing down communication channels between the RBS 36 and mobile station 90. The communication control circuits 52 may also allocate Walsh codes and perform power control functions. The communication control circuits 52 may be implemented in software, hardware, or some combination of both. For example, the communication control circuits 52 may be implemented as stored program instructions executed by one or more microprocessors or other logic circuits included in BSC 34.

FIG. 3 illustrates an alternative exemplary architecture for a wireless communications system 10′ that is less centralized than the wireless communications system 10 of FIGS. 1-2. Like the wireless communications system 10 of FIG. 1, the system 10′ of FIG. 3 includes a core network 20 having a PDSN 22, and a RAN 30 having a plurality of base stations 40′, which are advantageously identical to each other. In addition, the system 10′ of FIG. 3 includes an IP-based transport network 60, comprising one or more routers 62, that connect the core network 20 with RAN 30. In this exemplary architecture, the base stations 40′ are conceptually somewhat similar to the base stations 40 of FIG. 1, but with much of the “intelligence” of the BSC 34 distributed downward to be co-located with the RBS 36. FIG. 4 illustrates the logical elements of an exemplary base station 40′ for this system architecture. As shown in FIG. 4, each base station 40′ has an access network controller (ANC) 70 and a packet control function (PCF) 32′. ANC 70 functions similar to the communication control circuit 52 of FIG. 2's BSC 34 in that it manages radio resources for the associated RBS 36. PCF 32′ functions similar to PCF 32 of FIG. 1 in that it functions to establish, maintain, and terminate connections to the PDSN 22. With reference to FIG. 4, packet data between the base station 40′ and the PDSN 22 travels over an A10 communication link, while signaling data travels between the base station 40′ and PDSN 22 over an A11 link. Communications between ANCs 70 of different base stations 40′ travel over an A13 communication link; which is sometimes referred to as a sidehaul connection. The base stations 40′ may operate, for example, according to TIA-856-A, which defines an air interface between the base station 40′ and mobile station 90. Those skilled in the art will appreciate that the present invention may also use other air interface standards, as indicated above. Thus, the architecture of FIG. 3 is conceptually similar to that shown in FIG. 1, but with each RBS 36 in effect having its own co-located dedicated communications controller 52 (ANC 70) and PCF 32 (PCF 32′).

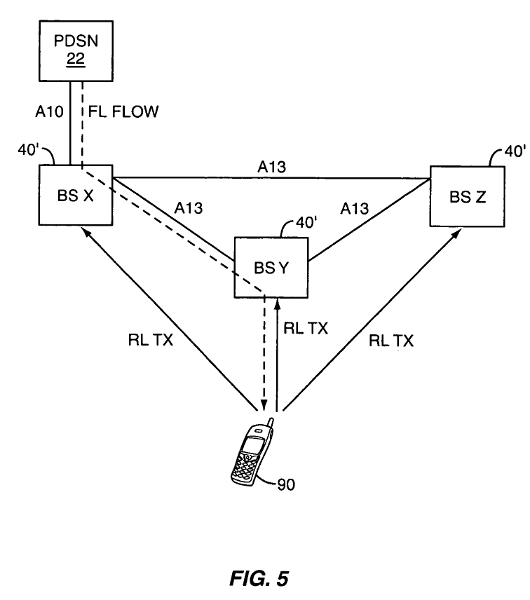

Turning to FIG. 5, one embodiment of the present invention will be explained in the context of the distributed architecture of FIG. 3. As shown in FIG. 5, several base stations 40′ may be receiving reverse link transmissions from a given mobile station 90. For simplicity, three base stations—labeled X, Y, and Z, are shown, but it should be understood that there may be more or less. The base stations 40′ communicate with each other using an A13 link, as discussed above. The set of base stations 40′ that should be receiving the reverse link transmissions are called the “active set” for that mobile station 90. Thus, base stations X, Y, and Z are considered, for purposes of this example, to be in the active set of the mobile station 90. Further, this example will assume that base station X is functioning as the call anchor, and that base station Y is the downlink serving base station. The call anchor forms the primary connection to the PDSN 22 using an A10 connection, and is typically the base station 40′ through which the mobile station 90 initially set up the communications session. The downlink serving base station is the base station 40′ that actually transmits the downlink data traffic to the mobile station 90 over the air interface. Note that these downlink, or forward link (FL) communications are shown in dashed lines in FIG. 5.

As illustrated in FIG. 5, the mobile station 90 transmits a reverse link (RL) packet (step 100). The base stations X, Y and Z all receive the reverse link transmissions from the mobile station 90. Looking first at primary base station Y, primary base station Y receives the reverse link packet (step 210) and determines if it has successfully received the packet (step 220). Thus, base station Y attempts to decode the reverse link packet, with a successful decoding indicating a successful reception of the packet. For example, base station Y may perform a CRC check on the packet to determine if decoding was successful. If the packet is not successfully received (e.g., CRC failure), base station Y simply awaits the next packet. If the packet is successfully received (e.g., CRC passes), then primary base station Y sends a forwarding control message to the other base stations 40′ in the active set (base stations X and Z in this example) on the sidehaul A13 link (step 240) and forwards the packet to the call anchor (step 290). The forwarding control message helps control whether or not the other base stations 40′ also send the packet to the call anchor, as explained further below. The relevant packet is identified in the forwarding control message, such as by suitable time stamp, flow identifier, and/or service reference identifier (SRID), etc. Turning now to the peer base station Z, sometimes referred to herein as a secondary base station, this base station 40′ also receives the reverse link packet (step 310) transmitted by the mobile station 90. Base station Z checks to see if the packet is received successfully (step 320), typically using a CRC check. Assuming base station Z successfully receives the packet, base station Z would, under the prior art, automatically forward the packet to the call anchor. However, in the present invention, base station Z instead starts a timer 72 (step 340) that governs a waiting period of predetermined duration before base station Z forwards the packet to the call anchor. If, during this waiting period, the forwarding control message is received (step 350), then the packet is not forwarded to the call anchor, and may be discarded (step 370). If the call forwarding control message is not received (step 350) before the timer expires (step 360), then base station Z forwards the packet to the call anchor (step 390). Base station X reacts in the same fashion as base station Z, but would in effect forward the packet to itself, as it is functioning as the call anchor. The call anchor then selection combines the received packets and processes the information in a conventional fashion.

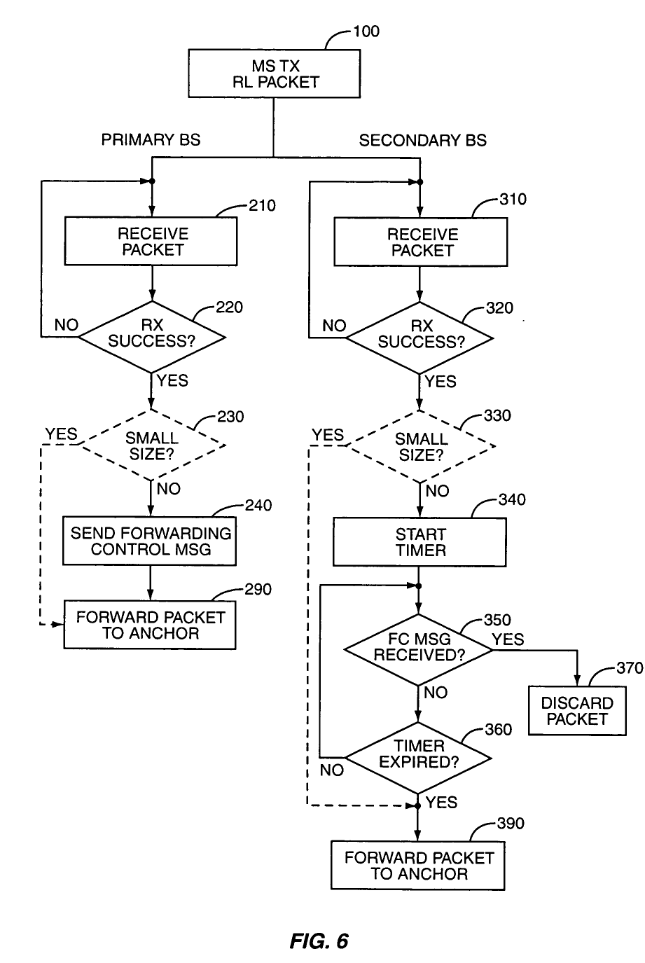

The processes described above may be augmented by selectively bypassing the forwarding control message sending/checking steps for small size packets, if desired. For example, the primary base station may look at the size of the packet (step 230), and bypass sending the forwarding control message (step 240) for small size packets. One rationale underlying this optional operation is that the use of the forwarding control message adds traffic to the A13 links, and using the forwarding control messages may not result in a net decrease in traffic for small packets. Likewise, the secondary base stations 40′ may examine the size of the successfully received packet (step 330), and bypass steps 340-370 for small size packets. Note that both step 230 and step 330 are shown in dashed lines in FIG. 6 due to their optional nature. Alternatively, or in addition, a similar bypass logic can be applied based on the packet belonging to certain application types, such as those that are known to be very delay intolerant and/or of typically small packet size. For example, VoIP applications may be relatively delay intolerant, due to quality of service restrictions, and typically use small packet sizes, and therefore steps 230, 330-370 may be bypassed for packets having VoIP application type data.

On a related note, the length of the predetermined waiting period at the secondary base stations 40′ may be constant for all packets. Or, alternatively, the length of the waiting period (i.e., setting of timer 72) may vary based on the packet's application type. For example, VoIP application packets may have very short waiting periods, while other application types may have longer waiting periods.

The discussion above assumed that the downlink serving base station Y was the “first among equals” base station 40′ from which the forwarding control messages originated. Thus, base station Y functioned as the primary base station; with the base stations 40′ targeted by the forwarding control messages, base stations X and Z, being the secondary base stations. However, while it is believed to be more efficient if the downlink serving base station 40′ functions as the primary base station, this is not required. In some embodiments, another base station 40′ in the active set, such as base station Z, may function as the primary base station if desired. Further, in some embodiments, a given base station 40′ may function as both the primary base station and the call anchor.

While the discussion above has been in terms of the wireless communication system 10 being configured according to the TIA-2000 standard, W-CDMA standard, or the 1xEV-DO standard, it should be realized that other packet data standards may alternatively be used, including without limitation systems using Worldwide Interoperability for Microwave Access (also known as WiMAX, see IEEE 802.16).

As used herein, the term “mobile station” 90 may include a cellular radiotelephone, a Personal Communications System (PCS) terminal that may combine a cellular radiotelephone with data processing, facsimile, and data communications capabilities; a Personal Data Assistant (PDA) that may include a pager, Web browser, radiotelephone, Internet/intranet access, organizer, calendar, and a conventional laptop and/or palmtop receiver or other appliances that include a radiotelephone transceiver.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of controlling packet forwarding operations of base stations in a wireless communications system, comprising a first base station:
receiving a reverse link packet from a mobile station;
determining if said packet was successfully received by said first base station; and
selectively sending a forwarding control message to at least one other peer base station based on said determining, said forwarding control message instructing said other base station to refrain from forwarding said packet to a call anchor associated with said mobile station.

2. The method of claim 1 further comprising said first base station forwarding said packet to said call anchor in response to said packet being successfully received.

3. The method of claim 1 wherein said selectively sending said forwarding control message comprises selectively sending said forwarding control message based on said determining and a size of said reverse link packet.

4. The method of claim 1 wherein said selectively sending said forwarding control message comprises selectively sending said forwarding control message based on said determining and an application type associated with said reverse link packet.

5. The method of claim 4 wherein said selectively sending said forwarding control message based on an application type associated with said reverse link packet comprises selectively sending said forwarding control message based on said determining and an acceptable delay associated with said application type.

6. The method of claim 1 wherein said first base station is said call anchor.

7. The method of claim 1 further comprising said first base station functioning as the downlink serving base station for said mobile station substantially contemporaneously with said receiving.

8. The method of claim 1
wherein said selectively sending said forwarding control message comprises selectively sending said forwarding control message based on a size of said reverse link packet and said determining indicating that said packet was successfully received; and
further comprising said first base station functioning as the downlink serving base station for said mobile station substantially contemporaneously with said receiving.

9. The method of claim 1
wherein said selectively sending said forwarding control message comprises selectively sending said forwarding control message based on said determining and an application type associated with said reverse link packet; and
further comprising said first base station functioning as the downlink serving base station for said mobile station substantially contemporaneously with said receiving.

10. A method of controlling packet forwarding operations of a base station in a wireless communications system, comprising:
successfully receiving a reverse link packet from a mobile station at a secondary base station;
buffering said packet;
receiving a corresponding forwarding control message from a primary base station instructing said secondary base station to refrain from forwarding said packet to a call anchor associated with said mobile station; and
said secondary base station selectively refraining from forwarding said packet to said call anchor based on said forwarding control message.

11. The method of claim 10 further comprising said secondary base station forwarding said packet to said call anchor if a predetermined time period elapses before said receipt of said corresponding forwarding control message.

12. The method of claim 11 wherein said predetermined time period varies based on an application type associated with said reverse link packet.

13. The method of claim 12 wherein said predetermined time period varies based on an acceptable delay associated with said application type.

14. A method of controlling packet forwarding operations of base stations in a wireless communications system, comprising:
successfully receiving a reverse link packet from a mobile station at a secondary base station;
determining whether to forward or refrain from forwarding said packet from said secondary base station to a call anchor associated with said mobile station based upon whether a corresponding forwarding control message is received from a primary base station prior to an expiration of a predetermined time period after said successful receipt of said packet; and
wherein said secondary base station refrains from forwarding said packet to said call anchor if said forwarding control message is received prior to said expiration.

15. The method of claim 14 wherein said predetermined time period varies at said secondary base station based on an application type associated with said reverse link packet.

16. The method of claim 15 wherein said predetermined time period varies based on an acceptable delay associated with said application type.

17. A method of controlling packet forwarding operations of base stations in a wireless communications system, comprising:
successfully receiving a reverse link packet from a mobile station at plurality of base stations, including a primary base station and at least one secondary base station;
said base stations normally programmed to forward said packet to an anchor processor responsible for said mobile station for selection combining at said anchor processor;
in response to said successful receipt of said packet, said primary base station sending a forwarding control message to said at least one secondary base stations;
each of said secondary base stations respectively selectively refraining from forwarding said packet to said anchor processor in response to receiving said forwarding control message prior to an expiration of a predetermined time period after said successful receipt of said packet by said secondary base station.

18. The method of claim 17 further comprising designating said primary base station from among a plurality of base stations able to receive transmissions from said mobile station.

19. The method of claim 17 wherein said primary base station is the serving base station providing downlink wireless service to said mobile station.

20. The method of claim 17 wherein said predetermined time period varies at said secondary base station based on an application type associated with said reverse link packet.

21. The method of claim 20 wherein said predetermined time period varies based on an acceptable delay associated with said application type.

22. A base station for a wireless communications system, comprising:
a receiver operative to receive reverse link packet transmissions from a mobile station; and
one or more processing circuits operatively coupled to said receiver and configured to:
determine if a packet was successfully received by said first base station; and
selectively send a forwarding control message to at least one other peer base station based on said determination, said forwarding control message instructing said other base station to refrain from forwarding said packet to a call anchor associated with said mobile station.

23. The base station of claim 22 wherein said one or more processing circuits are further configured to forward said packet to a call anchor associated with said mobile station based on said determination indicating said packet was successfully received.

24. A first base station for a wireless communications system, comprising:
a receiver operative to receive reverse link packet transmissions from a mobile station; and
one or more processing circuits operatively coupled to said receiver and configured to:
determine if a packet from said base station was successfully received by said first base station; and
if said packet was successfully received determining whether to forward or refrain from forwarding said packet from said first base station to a call anchor associated with said mobile station based upon whether a corresponding forwarding control message is received from a second base station prior to an expiration of a predetermined time period after said successful receipt of said packet; and
wherein said first base station refrains from forwarding said packet to said call anchor if said forwarding control message is received prior to said expiration.
